(19) United States
(12) Patent Application Publication
(10) Pub. No.: US 2025/0282565 A1
(43) Pub. Date: Sep. 11, 2025

(54) SUPPORTING DEVICE AND PRINTING DEVICE

(71) Applicant: SEIKO EPSON CORPORATION, Tokyo (JP)

(72) Inventor: Yusuke WATANABE, AZUMINO-SHI (JP)

(21) Appl. No.: 19/070,913

(22) Filed: Mar. 5, 2025

(30) Foreign Application Priority Data
Mar. 7, 2024 (JP) 2024-034663

(51) Int. Cl. B65H 1/04; B41J 11/00; B41J 13/10

(52) U.S. Cl. CPC B65H 1/04; B41J 11/0035; B41J 13/103; B65H 2301/5132

(57) ABSTRACT

A supporting device 2 includes a support section 4 configured to support films MA and MB on a support surface 4a, a static electricity generating section 41 configured to generate static electricity at a static electricity generation locations 41A and 41B provided at a part of the support surface 4a, and a positioning reference section 41 that is provided at the support surface 4a and that indicates at least a part of a placing position at which the films MA and MB, wherein the positioning reference section 41 is disposed in accordance with the predetermined shape such that a part of the films MA and MB and the static electricity generation locations 41A and 41B overlap each other in a support direction.

The present application is based on, and claims priority from JP Application Serial Number 2024-034663, filed Mar. 7, 2024, the disclosure of which is hereby incorporated by reference herein in its entirety.

### BACKGROUND

### 1. Technical Field

The present disclosure relates to a supporting device and a printing device.

### 2. Related Art

In the related art, printing devices with various configurations have been used. Among such printing devices, there is a printing device that includes a support section that supports a medium on a support surface and that is configured to perform printing on the medium supported by the support section. For example, JP-A-2018-138361 discloses a printing device capable of printing on a medium supported on a tray by placing the medium on the support surface of the tray and describes that the medium is prevented from moving relative to the support surface by disposing a friction member on the tray.

However, when the medium such as a film is used, even in a configuration where a friction member is disposed on the support surface, there may be cases where the film warps or floats with respect to the support surface. Therefore, for example, for a sheet-like medium such as a film that tends to warp and float, it has been necessary to wet the back surface of the medium with water, to lay a mat made of silicon or the like on the entire surface of the support surface, to attach and fix the medium to the support surface with adhesive tape, or to use a member for holding the medium. However, in such methods, there is a possibility that water or the like may enter the device, the positioning of the medium on the support surface and the removal of the medium from the support surface become difficult, and print quality decreases due to the large distance between the support surface and the printing section. Apart from such a problem, there is a problem where it is difficult to understand the position for placing the sheet-like medium on the support surface, and sometimes a guide for the placement position of the sheet-like medium is required.

### SUMMARY

A supporting device of the present disclosure for solving the above problem, the supporting device includes a support section configured to support a film on a support surface; a static electricity generating section configured to generate static electricity at a static electricity generation location provided at a part of the support surface; and a positioning reference section that is provided at the support surface and that indicates at least a part of a placing position where the film having a predetermined shape is placed, wherein the positioning reference section is disposed in accordance with the predetermined shape such that a part of the film and the static electricity generation location overlap each other in a support direction of the film by the support surface.

A printing device of the present disclosure for solving the above problem, the printing device includes a support section configured to support a film on a support surface; a printing section configured to perform printing on the film supported by the support surface; a static electricity generating section configured to generate static electricity at a static electricity generation location provided at a part of the support surface; and a positioning reference section that is provided at the support surface and that indicates at least a part of a placing position where the film having a predetermined shape is placed, wherein the positioning reference section is disposed in accordance with the predetermined shape such that a part of the film and the static electricity generation location overlap each other in a support direction of the film by the support surface.

### BRIEF DESCRIPTION OF THE DRAWINGS

FIG. 1 is a schematic perspective view showing a printing device according to a first embodiment of the present disclosure.

FIG. 2 is a schematic front view of the printing device of FIG. 1.

FIG. 3 is a schematic plan view showing a support section of a supporting device in the printing device of FIG. 1.

FIG. 4 is a schematic plan view showing a state in which films of two types of sizes are disposed on the support section of FIG. 3.

FIG. 5 is a schematic plan view showing a state in which the films of two types of sizes are disposed on the support section of the supporting device in the printing device of a second embodiment of the present disclosure.

FIG. 6 is a schematic plan view showing a state in which the films of two types of sizes are disposed on the support section of the supporting device in the printing device of a third embodiment of the present disclosure.

FIG. 7 is a schematic plan view showing a state in which the films of two types of sizes are disposed on the support section of the supporting device in the printing device of a fourth embodiment of the present disclosure.

FIG. 8 is a schematic plan view showing a state in which the film is disposed on the support section of the supporting device in the printing device of a reference example.

### DESCRIPTION OF EMBODIMENTS

First, the present disclosure will be schematically described.

A supporting device of a first aspect of the present disclosure for solving the above problem, the supporting device includes a support section configured to support a film on a support surface; a static electricity generating section configured to generate static electricity at a static electricity generation location provided at a part of the support surface; and a positioning reference section that is provided at the support surface and that indicates at least a part of a placing position where the film having a predetermined shape is placed, wherein the positioning reference section is disposed in accordance with the predetermined shape such that a part of the film and the static electricity generation location overlap each other in a support direction of the film by the support surface.

According to the present aspect, the static electricity generating section configured to generate the static electricity at the static electricity generation location and the positioning reference section that indicates at least a portion of the placing position are provided, and the positioning reference section is disposed such that a part of the film and the static electricity generation location overlap each other in the support direction in accordance with the predetermined shape of the film. With such a configuration, it is possible to place the film at an optimal position on the support surface using the positioning reference section and it is possible to suppress warp or float of the film by generating the static electricity and attracting the film to the support surface.

The supporting device of a second aspect of the present disclosure is an aspect according on the first aspect, wherein the positioning reference section is visually distinguishably indicated on the support surface.

According to the present aspect, the positioning reference section is visually distinguishably indicated on the support surface. Therefore, the user can easily place the film at an optimum position on the support surface.

The supporting device of a third aspect of the present disclosure is an aspect according to the second aspect, wherein the positioning reference section is indicated in a color different from the surroundings on the support surface.

According to the present aspect, the positioning reference section is indicated in a color different from the surroundings on the support surface. With such a configuration, the positioning reference section can be easily configured.

The supporting device of a fourth aspect of the present disclosure is an aspect according to the any one of the first to third aspects, wherein the positioning reference section is indicated by a surface shape different from the surroundings on the support surface.

According to the present aspect, the positioning reference section is indicated with the surface shape different from surroundings on the support surface. With such a configuration, for example, a monochromatic support surface can be provided.

The supporting device of a fifth aspect of the present disclosure is an aspect according to the first aspect, wherein the positioning reference section is disposed at a position that overlaps with the static electricity generating section in the support direction.

According to the present aspect, the positioning reference section and the static electricity generating section are disposed at the overlapping position. Therefore, the positioning reference section and the static electricity generating section can be made common and the device configuration can be simplified.

The supporting device of a sixth aspect of the present disclosure is an aspect according to the first aspect, wherein the positioning reference section is disposed at a position that does not overlap with the placing location of the film in the support direction and has a protrusion step configured to contact the film in a direction that intersects the support direction.

According to the present aspect, it is possible to position the film while preventing the positioning reference section and the placing location of the film from overlapping each other. With such a configuration, it is possible to easily position the film at a desired position on the support surface and it is possible to prevent the film from protruding in the support direction due to the overlap of the positioning reference section and the film in the support direction.

The supporting device of a seventh aspect of the present disclosure is an aspect according to the sixth aspect, wherein the protrusion step is a step less than or equal to the thickness of the film.

According to the present aspect, the protrusion step is a step less than or equal to the thickness of the film. With such a configuration, it is possible to prevent the protrusion step from becoming an obstacle.

The supporting device of an eighth aspect of the present disclosure is an aspect according to the first aspect, wherein the film is rectangular and the positioning reference section corresponds to a position that is overlapped by a corner of the film.

According to the present aspect, the film is rectangular and the positioning reference section corresponds to the position that is overlapped by the corners of the film. With such a configuration, it is possible to easily place the rectangular film on the support surface at a desired position.

The supporting device of a ninth aspect of the present disclosure is an aspect according to the first aspect, wherein the film is rectangular and the positioning reference section corresponds to a position along which an edge of the film is to be aligned.

According to the present aspect, the film is rectangular and the positioning reference section corresponds to the position along which the edge of the film is to be aligned. With such a configuration, it is possible to easily place the rectangular film on the support surface at a desired position.

The supporting device of a tenth aspect of the present disclosure is an aspect according to the first aspect, wherein the support section is configured to support films of different sizes and the positioning reference section is disposed corresponding to the films of different sizes.

According to the present aspect, the support section is configured to support the films of different sizes and the positioning reference section is disposed corresponding to the films of different sizes. Therefore, even when the films of different sizes are used, the film can be placed at a suitable position on the support surface according to the size of the film.

The supporting device of a eleventh aspect of the present disclosure is an aspect according to the tenth aspect, wherein a plurality of different types of positioning reference sections are disposed so as to be distinguishable from each other in accordance with the films of different sizes.

According to the present aspect, the positioning reference sections are disposed in the plurality of different types so as to be distinguishable from each other in accordance with the films of different sizes. Therefore, even when the films of different sizes are used without changing the position of the positioning reference section, the film can be placed at a suitable position on the support surface according to the size of the film.

The supporting device of a twelfth aspect of the present disclosure is an aspect according to the tenth aspect, wherein the static electricity generating section is configured to switch the occurrence state of static electricity in accordance with films of different sizes.

According to the present aspect, the static electricity generating section is configured to switch the occurrence state of the static electricity in accordance with films of different sizes. Therefore, the occurrence state of the static electricity can be suitably switched in accordance with the size of the film.

A printing device of a thirteenth aspect of the present disclosure, the printing device includes a support section configured to support a film on a support surface; a printing section configured to perform printing on the film supported by the support surface; a static electricity generating section configured to generate static electricity at a static electricity generation location provided at a part of the support surface; and a positioning reference section that is provided at the support surface and that indicates at least a part of a placing position where the film having a predetermined shape is placed, wherein the positioning reference section is disposed in accordance with the predetermined shape such that a part of the film and the static electricity generation location overlap each other in a support direction of the film by the support surface.

According to the present aspect, the static electricity generating section configured to generate the static electricity at the static electricity generation location and the positioning reference section that indicates at least a portion of the placing position are provided, and the positioning reference section is disposed such that a part of the film and the static electricity generation location overlap each other in the support direction in accordance with the predetermined shape of the film. With such a configuration, it is possible to place the film at an optimal position on the support surface using the positioning reference section and it is possible to suppress warp or float of the film by generating the static electricity and attracting the film to the support surface.

### First Embodiment

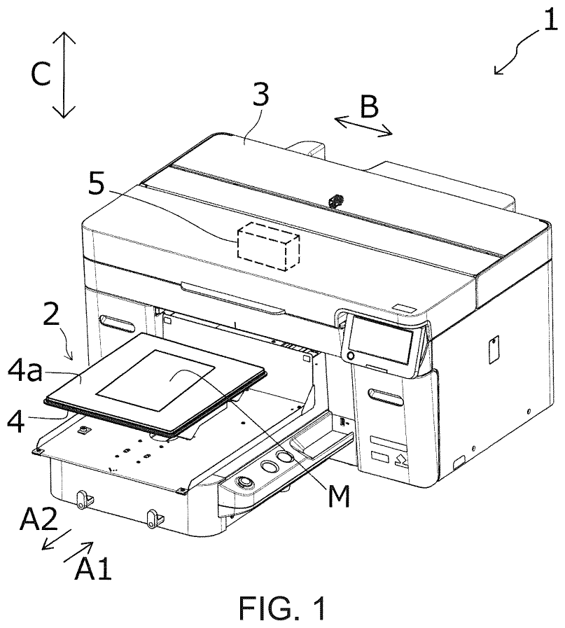

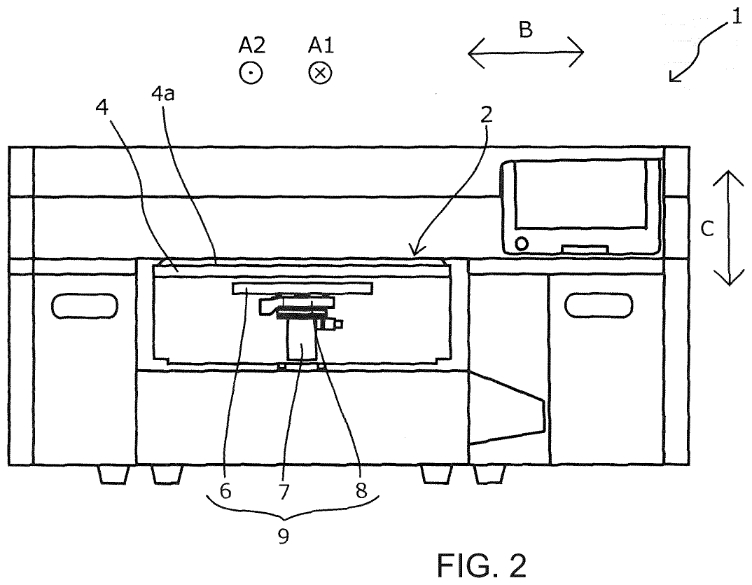

Hereinafter, a printing device 1 and a supporting device 2 provided in the printing device 1 according to the present disclosure will be described with reference to the accompanying drawings. First, an outline of the printing device 1 according to the first embodiment of the present disclosure will be described with reference to FIG. 1 and FIG. 2. FIG. 1 is a schematic perspective view of printing device 1 according to the present embodiment.

As shown in FIG. 1, the printing device 1 according to the present embodiment includes a supporting device 2 (supporting device 2A) having a platen 4 as a support section on which a sheet-like print medium M can be placed. The supporting device 2A can be considered as a medium transport section and is configured to be capable of moving the platen 4 in a direction A1 and a direction A2. A main body section 3 of the printing device 1 is provided with a printing section 5 capable of reciprocating in the width direction B, which intersects the direction A1 and the direction A2. The direction in which the print medium M is supported by the platen 4 is a support direction C corresponding to a vertical direction.

As shown in FIG. 2, the supporting device 2A of the present embodiment is provided with a placing section 6 for placing the platen 4, an attaching section 7, which is movable in the direction A1 and direction A2 and to which the placing section 6 can be attached, and a lever 8, which can change the height of the placing section 6. The placing section 6, the attaching section 7, and the lever 8 constitute a connecting section 9 of the platen 4.

Note that the supporting device 2A of the present embodiment can be provided on the platen 4 with a support section side engagement section, which can be engaged with a device side engagement section included in the printing device 1. The device side engagement section can be provided in the placing section 6. By changing the engagement state of the support section side engagement section with respect to the device side engagement section, the supporting device 2A makes it possible to attach and detach the platen 4 from the connecting section 9. In other words, by engaging the support section side engagement section to the device side engagement section, the supporting device 2A of the present embodiment can attach platens 4 with various configurations. Therefore, by replacing the platen 4, the printing device 1 of the present embodiment can print on the print mediums M of various shapes and materials such as a sheet-like print medium M such as a film and a fabric such as a T-shirt. However, it is not limited to such a configuration, the platen 4 and the connecting section 9 may be integrally formed and the platen 4 may not be detached from the printing device 1.

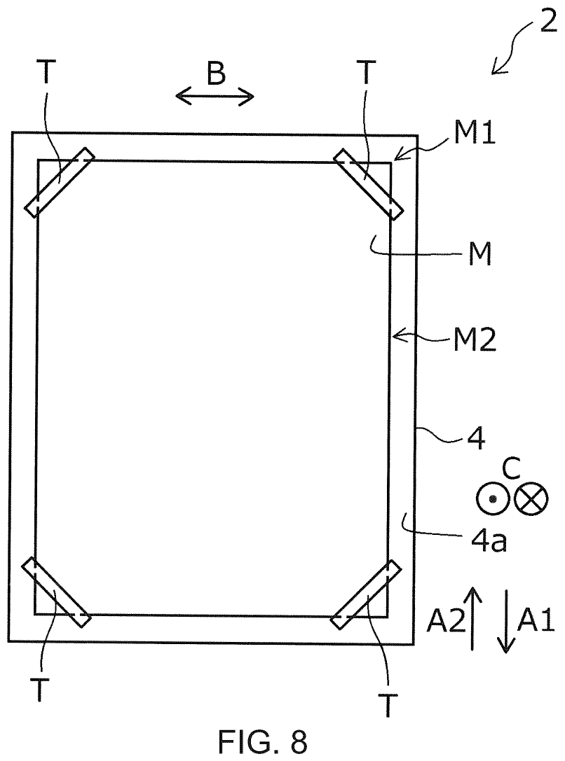

The printing device 1 of the present embodiment has a configuration in which the platen 4 is moved in the direction A1 from a state in which the platen 4 on which the print medium M is placed is disposed at the position shown in FIG. 1, and then printing can be executed by ejecting ink from the printing section 5 while moving the platen 4 in the direction A2. In the printing device 1 of the present embodiment, a resin film can be desirably used as the print medium M. However, as the print medium M, in addition to the film made of resin, for example, various mediums such as a fabric such as a T-shirt can be used. In general, the film is slippery relative to a support surface 4a of the platen 4. Therefore, in the related art, when a rectangular film, for example, is used as the print medium M, the corners M1 are fixed using tape T or the like as shown in FIG. 8.

However, in a case where the corners M1 of the print medium M is fixed by the tape T, the gap between the support surface 4a of the platen 4 and the printing section 5 in the support direction C needs to be increased in order to suppress contact between the tape T and the printing section 5. However, when the gap between the support surface 4a and the printing section 5 in the support direction C is too large, there is a concern that the printing quality may decrease.

Alternatively, a method of misting water on the support surface 4a of the platen 4 and placing and fixing the print medium M thereon is also conceivable, but in such a method, in addition to becoming difficult to remove the print medium M from the support surface 4a, there is a possibility that water enters the printing device 1 and water adheres to the printing section 5 When the film is used as the print medium M, a transfer medium may also be used as the film, and in such cases, it generally deposits a powder form resin, which is used for transfer, to the ink that was ejected to the film. However, when misting water on the support surface 4a of the platen 4, the powder form resin may adhere to the printing device or a portion of the film where ink is not ejected.

It is conceivable to place a silicon mat or the like on the entire surface of the support surface 4a of the platen 4 and place the print medium M thereon, but by such a method, the entire surface of the print medium M is fixed. This makes it difficult to align the print medium M on the support surface 4a and also makes it difficult to remove the print medium M.

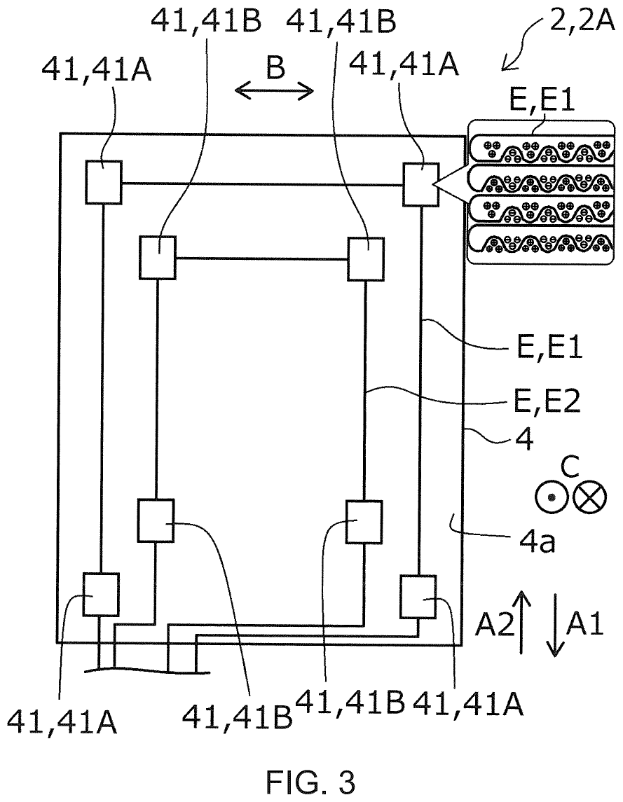

Next, the supporting device 2A, which is a main part of the printing device 1 of the present embodiment, will be described in detail. As described above, the supporting device 2A of the present embodiment is provided with the platen 4 for supporting the film as the print medium M on the support surface 4a and the connecting section 9 for connecting the platen 4 when printing is performed on the film. As shown in FIG. 3, static electricity generating sections 41 for generating static electricity are provided at static electricity generation locations 41A and 41B provided at a part of the support surface 4a.

In the printing device 1 of the present embodiment, the static electricity generation locations 41A correspond to the static electricity generation locations when an A3 size film MA is used and the static electricity generation locations 41B correspond to the static electricity generation locations when a A4 size film MB is used. However, the static electricity generation locations 41A correspond to the outside of a printing range when the A3 size film MA is used, and the static electricity generation locations 41B correspond to the outside of a printing range when the A4 size film MB is used. Therefore, even when ink mist or the like is attracted to the static electricity generation locations 41A or the static electricity generation locations 41B, a decrease in quality of the image formed in the printing range is suppressed. Note that in the printing device 1, the entire support surface 4a is within a printable range, so it is possible to place films of different shapes and sizes by providing the static electricity generating sections 41 on the support surface 4a at positions different from the static electricity generation locations 41A or the static electricity generation locations 41B.

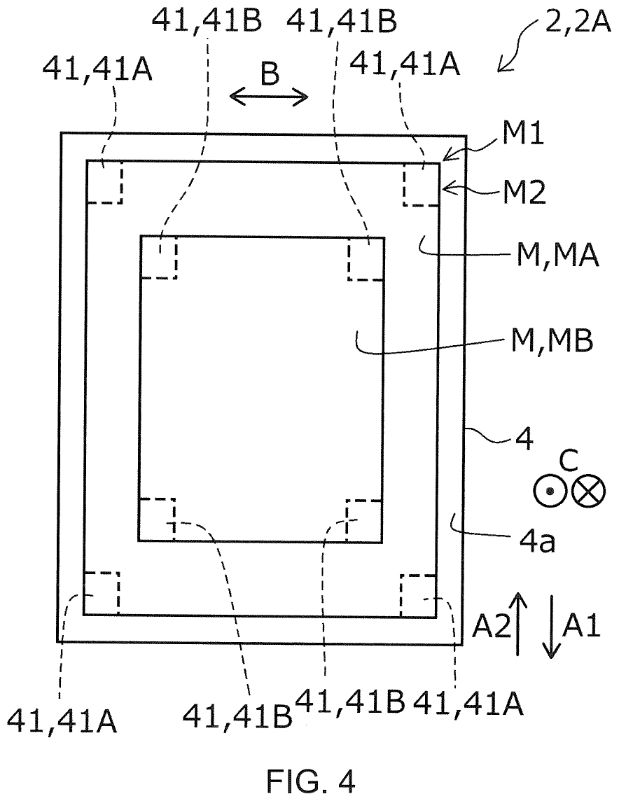

Here, the static electricity generating sections 41 are provided at the support surface 4a and also serves as the positioning reference section indicating at least a part of the placing position for placing the film. In detail, the static electricity generating sections 41 as the positioning reference sections, as shown in FIG. 4, are disposed so that a part of the film such as corners M1 and the static electricity generation locations 41A and 41B overlap in the support direction C of the film by the support surface 4a, in accordance with a predetermined shape of the film. The static electricity generating sections 41 as the positioning reference sections are disposed so as to be able to align a part of the outer shape of the film.

Thus, the supporting device 2A of the present embodiment is provided with the static electricity generating sections 41, which also serve as the positioning reference sections indicating at least a part of the placing position of the film, and generate the static electricity at the static electricity generation locations 41A and 41B. The static electricity generating sections 41 are disposed so that a part of the film and the static electricity generation locations 41A and 41B overlap in the support direction C in accordance with a predetermined shape of the film MA and the film MB. With such a configuration in the supporting device 2A of the present embodiment, the film can be placed at the optimal position on the support surface 4a, and by generating static electricity to adhere the film to the support surface 4a, it is configured to suppress warp or float of the film. In the present embodiment, predetermined shape refers to the A3 size and A4 size, but it may also be other sizes or shapes.

Note that the positioning reference sections may be provided separately from the static electricity generating sections 41. When the positioning reference sections are provided separately from the static electricity generating sections 41, the positioning reference sections may be disposed at a position along the outer shape of the film without overlapping the film. It is desirable that the positioning reference sections are disposed at positions where, when the film is placed on the support surface 4a along the outer shape of the film, the static electricity generating sections 41 and the film overlap outside the printing range when the film is used.

From the viewpoint of the printing device 1, the printing device 1 of the present embodiment includes the printing section 5 that performs printing on the film supported by the support surface 4a of the support section 4 that supports the film by the support surface 4a. With providing the supporting device 2A having the above described configuration, the film can be placed at the optimal position on the support surface 4a, and by generating static electricity to adhere the film to the support surface 4a, it is configured to suppress warp or float of the film.

As described above, in the supporting device 2A of the present embodiment, the static electricity generating sections 41 also serves as the positioning reference section. In other words, the positioning reference sections are disposed at the positions overlapping the static electricity generating sections 41 in the support direction C. Since the supporting device 2A of the present embodiment has such a configuration, the positioning reference sections and the static electricity generating sections 41 can be made common and the device configuration can be simplified.

Here, in the supporting device 2A of the present embodiment, the static electricity generating sections 41 as the positioning reference sections are visually distinguishably shown on support surface 4a. Therefore, the user can easily place the film at the optimum position on the support surface 4a.

In detail, the static electricity generating sections 41 as the positioning reference sections are shown in a color different from the surroundings on the support surface 4a. Specifically, the support surface 4a is substantially transparent in color, while the static electricity generation locations 41A are black and the static electricity generation locations 41B are gray. With such a configuration, the positioning reference section can be easily configured. Note that the color of the static electricity generating sections 41 is not particularly limited.

However, it is not limited to such a configuration. For example, the positioning reference sections may have a surface shape different from that of the surroundings on the support surface 4a. With such a configuration, for example, a monochromatic support surface 4a can be provided. Note that different surface shapes include, for example, a difference in glossiness or a difference in pattern between the portion of the support surface 4a where the positioning reference section is provided and other portions.

As shown in FIG. 4, the supporting device 2A of the present embodiment can desirably use an A3 size rectangular film and an A4 size rectangular film. By using such films as the print medium M, the position of the static electricity generating sections 41 as the positioning reference sections can be made to correspond to the position that is overlapped by the corners M1 of the film. Since the supporting device 2A of the present embodiment has such a configuration, it is possible to easily place the rectangular film on the support surface 4a at a desired position.

As shown in FIG. 4, in the supporting device 2A of the present embodiment, the static electricity generating sections 41 are also rectangular and it is possible to position the film on the support surface 4a by aligning the edges M2 of the film with portions corresponding to the edges of the static electricity generating sections 41. Since the supporting device 2A of the present embodiment has such a configuration, it is possible to easily place the rectangular film on the support surface 4a at a desired position.

As described above, the platen 4 can support films of different sizes, such as A3 size film MA and A4 size film MB. The static electricity generating sections 41 as the positioning reference sections are disposed in correspondence with the films of different sizes. Therefore, in the supporting device 2A of the present embodiment, even when films of different sizes are used, the film can be placed at a suitable position on the support surface 4a according to the size of the film.

As described above, the static electricity generation locations 41A are black and the static electricity generation locations 41B are gray. That is, in the supporting device 2A of the present embodiment, plural types of static electricity generating sections 41 as the positioning reference sections are disposed so as to be distinguishable from each other in accordance with the films of different sizes. Therefore, in the supporting device 2A of the present embodiment, even when the films of different sizes are used without changing the position of the positioning reference section, the film can be placed at a suitable position on the support surface 4a according to the size of the film.

As shown in FIG. 3, in the supporting device 2A of the present embodiment, the static electricity generating sections 41 disposed at the static electricity generation locations 41A are connected by wiring E1 of wiring E, and the static electricity generating sections 41 disposed at the static electricity generation locations 41B are connected by wiring E2 of the wiring E. Since the supporting device 2A of the present embodiment has such a configuration, when the A3 size film MA is used, only the static electricity generating sections 41 disposed at the static electricity generation locations 41A are energized to generate the static electricity, and when the A4 size film MB is used, only the static electricity generating sections 41 disposed at the static electricity generation locations 41B are energized to generate the static electricity.

In other words, in the supporting device 2A according to the present embodiment, the static electricity generating sections 41 can switch the occurrence state in which static electricity is generated in accordance with films having different sizes. Therefore, in the supporting device 2A of the present embodiment, the occurrence state of static electricity can be suitably switched in accordance with the size of the film. However, for example, when the A3 size film MA is used, it is also possible to energize the static electricity generating sections 41 disposed at the static electricity generation locations 41B.

Note that in the present embodiment, the power supply for energizing the static electricity generating sections 41 is supplied from the power supply of the printing device 1, and the energization of the wiring E1 and the wiring E2 is automatically performed under the control of a control section (not shown) provided at the main body section 3 of the printing device 1. The control section can turn off the energization to the wiring E1 and the wiring E2 in conjunction with the power of the printing device 1 being turned off. It is also possible to turn off the energization to the wiring E1 and the wiring E2 in conjunction with the end of printing, the end of the movement of the platen 4 in the direction A1 and the direction A2, or the like. By turning on the energization to the static electricity generating sections 41, the film can be attracted to the support surface 4a, and by turning off the energization to the static electricity generating sections 41, the film can be easily removed from the support surface 4a.

However, it is not limited to such a configuration. For example, a switch or the like that can be manually operated by the user may be provided in the main body section 3 and it be may be configured so that the user manually energizes the wiring E1 and the wiring E2. The switch may be provided on the supporting device 2A. For example, an energizing section energizing the wiring E by a mounted power supply such as a battery may be provided on a surface opposite to the support surface 4a of the platen 4. By providing the switch and the mounted power supply, the supporting device 2A itself can cause the film to cling to the support surface 4a and enable removal of the film from the support surface 4a. Therefore, in the printing device 1, by exchanging the supporting device 2A with the film placed on the support surface 4a with another supporting device 2A, it is possible to replace the film to be printed. For example, a lighting section such as an LED light may be installed, which is illuminated when wiring E is energized, and not illuminated when wiring E is not energized, thus making it easy for the user to understand whether wiring E is energized or not.

As shown in the enlarged view of FIG. 3, in the supporting device 2A of the present embodiment, the static electricity generating sections 41 are designed to apply both positive and negative charges to the support surface 4a, but it is not limited to this configuration. Only one of positive charge or negative charge may be disposed on the support surface 4a. Instead of the energization type static electricity generating section, a static electricity generating section that generates the static electricity by rubbing may be used.

### Second Embodiment

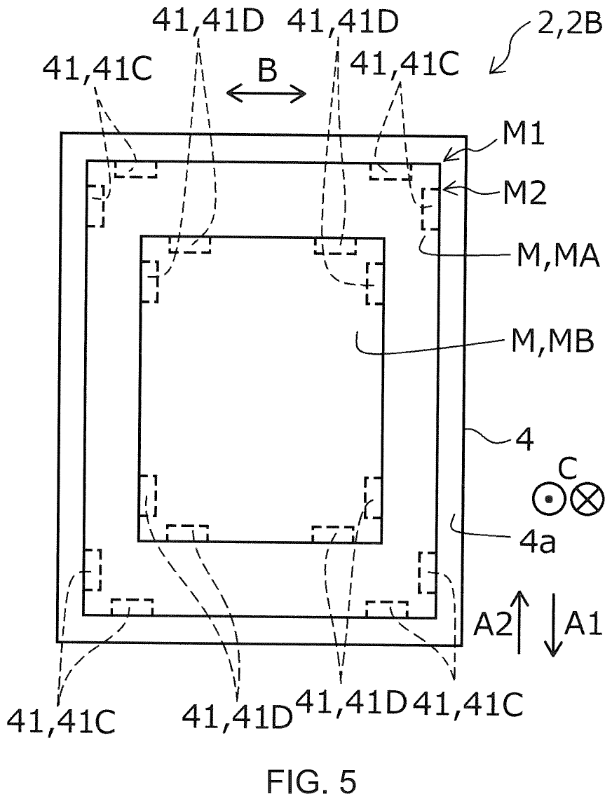

Next, the printing device 1 according to a second embodiment will be described with reference to FIG. 5. Here, FIG. 5 is a diagram corresponding to FIG. 4 of the printing device 1 of the first embodiment. The printing device 1 according to the present embodiment is the same as the printing device 1 according to the first embodiment except for the configuration of the supporting device 2, which will be described below, and therefore has the same features as the printing device 1 of the first embodiment. Therefore, in FIG. 5, portions common to the first embodiment are denoted by the same reference symbols, and a detailed description thereof will be omitted.

A supporting device 2B of the printing device 1 of the present embodiment includes static electricity generating sections 41 having a shape different from that of the supporting device 2A of the printing device 1 of the first embodiment. Specifically, as shown in FIG. 5, the static electricity generating sections 41 are disposed separately in the vicinity of each of the four corners M1 of the rectangular film. In detail, it includes the static electricity generating sections 41 for generating the static electricity at static electricity generation locations 41C when using the A3 size film MA and the static electricity generating sections 41 for generating the static electricity at static electricity generation locations 41D when using the A4 size film MB. Each of the static electricity generating sections 41 is configured to align the film on the support surface 4a by causing a portion corresponding to the edges of the static electricity generating sections 41 and edges M2 of the film to be along each other.

### Third Embodiment

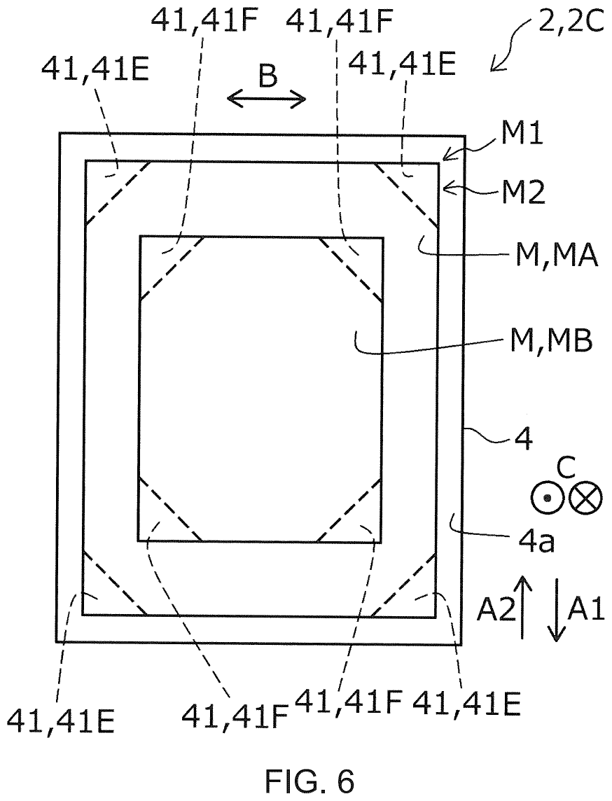

Next, the printing device 1 according to a third embodiment will be described with reference to FIG. 6. Here, FIG. 6 is a diagram corresponding to FIG. 4 of the printing device 1 of the first embodiment. The printing device 1 according to the present embodiment is the same as the printing device 1 according to the first and second embodiments except for the configuration of the supporting device 2, which will be described below, and therefore has the same features as the printing device 1 according to the first and second embodiments. Therefore, in FIG. 6, portions common to the first and second embodiments are denoted by the same reference symbols, and a detailed description thereof will be omitted.

A supporting device 2C of the printing device 1 of the present embodiment includes static electricity generating sections 41 having a shape different from that of the supporting device 2A of the printing device 1 of the first embodiment and the supporting device 2B of the printing device 1 of the second embodiment. Specifically, as shown in FIG. 6, the static electricity generating sections 41 having a right-angled isosceles triangle shape is arranged corresponding to each of the four corners M1 of the rectangular film. In detail, it includes the static electricity generating sections 41 for generating the static electricity at static electricity generation locations 41E when using the A3 size film MA and the static electricity generating sections 41 for generating the static electricity at static electricity generation locations 41F when using the A4 size film MB. Each of the static electricity generating sections 41 is configured to align the film on the support surface 4a by causing a portion corresponding to the corners of the static electricity generating sections 41 and the corners M1 of the film to overlap each other. Note that by forming the static electricity generating sections 41 into a right-angled isosceles triangle, it is possible to further reduce the risk of ink mist or the like adhering to the printing range as compared with the case of forming the static electricity generating sections 41 into a rectangle.

The shape of the static electricity generation locations 41E and the static electricity generation locations 41F is not limited to a right-angled isosceles triangle. As long as it has a right-angled portion and edges with which the corner M1 and the edges M2 of the film can be aligned, the lengths of the two edges may be different from each other, or may be fan-shaped instead of triangular. With respect to the shape of the static electricity generation locations 41E and the static electricity generation locations 41F, when the lengths of the two edges used for the alignment of edges M2 of the film are different, the edge along the long edge of edge M2 of the film may be made longer compared to the edge along the short edge of edge M2 of the film.

### Fourth Embodiment

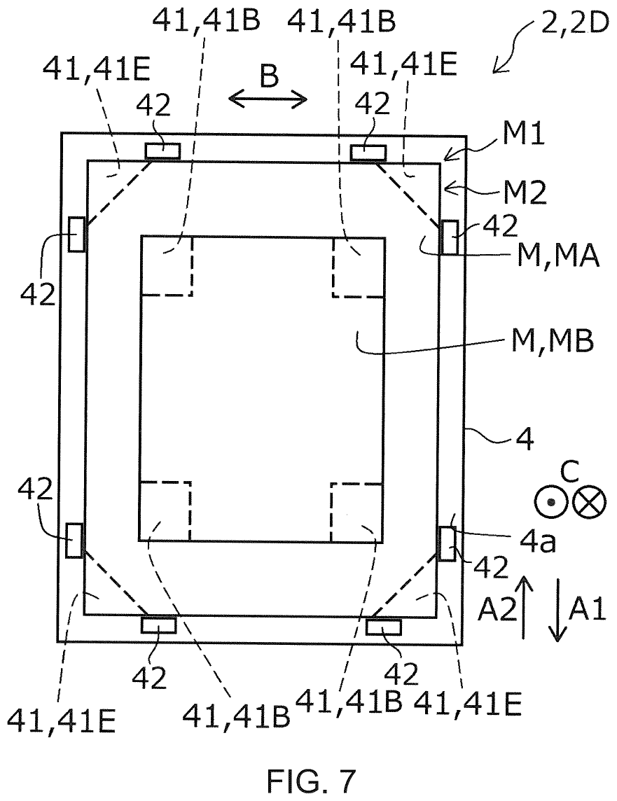

Next, the printing device 1 according to a fourth embodiment will be described with reference to FIG. 7. Here, FIG. 7 is a diagram corresponding to FIG. 4 of the printing device 1 of the first embodiment. The printing device 1 according to the present embodiment is the same as the printing device 1 according to the first to third embodiments except for the configuration of the supporting device 2, which will be described below, and therefore has the same features as the printing device 1 according to the first to third embodiments. Therefore, in FIG. 7, portions common to the first to third embodiments are denoted by the same reference symbols, and a detailed description thereof will be omitted.

A supporting device 2D of the printing device 1 in the present embodiment includes the static electricity generating sections 41 with a configuration similar to that of the supporting device 2A of the printing device 1 of the first embodiment and the static electricity generating sections 41 with a configuration similar to that of the supporting device 2C of the printing device 1 of the third embodiment. Specifically, as shown in FIG. 7, the static electricity generating sections 41 having a right-angled isosceles triangle shape is disposed corresponding to each of the four corners M1 of the A3 size rectangular film MA, and the static electricity generating sections 41 having a rectangular shape is disposed corresponding to the four corners M1 of the A4 size rectangular film MB.

As shown in FIG. 7, the supporting device 2D of the printing device 1 according to the present embodiment includes a plurality of rectangular positioning reference sections 42, which constitute a protrusion step with respect to the support surface 4a, separately from the static electricity generating sections 41. In the supporting device 2D of the printing device 1 of the present embodiment, when an A3 size rectangular film MA is used, the film can be aligned on the support surface 4a by butting the edge M2 of the film against the edge of the rectangular positioning reference sections 42 in a surface direction (horizontal direction) of the support surface 4a. The rectangular positioning reference sections 42 are disposed so that positioning can be performed by butting a part of the outer shape of the film against them.

In other words, in the supporting device 2D of the present embodiment, the positioning reference sections 42 are capable of abutting the film MA in a direction that intersects the support direction C, and have a protrusion step disposed at a position that does not overlap with the placing location of the film in the support direction C. Since the supporting device 2D of the present embodiment has such a configuration, it is possible to easily position the film at a desired position on the support surface 4a and it is possible to prevent the film from protruding in the support direction C due to the overlap of the positioning reference sections 42 and the film in the support direction C.

Note that one of the four corners M1 of the film MB may be aligned with the positioning reference section 42. The positioning reference section 42 may be disposed such that the film MA is aligned and placed using one of the four corners M1. That is, only the positioning reference section 42 for positioning one of the four corners M1 of the film may be disposed and the film MA and the film MB may be used as a common positioning reference section.

Here, in the supporting device 2D of the present embodiment, the protrusion step is a stepless than or equal to the thickness of the film. With such a configuration, for example, it is possible to prevent the protrusion step from becoming an obstacle, for example, by contacting the printing section 5 with the protrusion step during a printing operation.

Note that the present disclosure is not limited to the above described embodiments, and various modifications can be made within the scope of the disclosure described in the claims, and it goes without saying that these are also included within the scope of the present disclosure. For example, in the platen 4 having the configuration of the above embodiment, the static electricity generating section 41 may be further provided in the center of the support surface 4a, and the arrangement, size, and shape of the static electricity generating sections 41 and the positioning reference sections 42 may be configured in a manner other than that of the above embodiment.

What is claimed is:

1. A supporting device comprising:
a support section configured to support a film on a support surface;
a static electricity generating section configured to generate static electricity at a static electricity generation location provided at a part of the support surface; and
a positioning reference section that is provided at the support surface and that indicates at least a part of a placing position where the film having a predetermined shape is placed, wherein
the positioning reference section is disposed in accordance with the predetermined shape such that a part of the film and the static electricity generation location overlap each other in a support direction of the film by the support surface.

2. The supporting device according to claim 1, wherein
the positioning reference section is visually distinguishably indicated on the support surface.

3. The supporting device according to claim 2, wherein
the positioning reference section is indicated in a color different from the surroundings on the support surface.

4. The supporting device according to claim 2, wherein
the positioning reference section is indicated by a surface shape different from the surroundings on the support surface.

5. The supporting device according to claim 1, wherein
the positioning reference section is disposed at a position that overlaps with the static electricity generating section in the support direction.

6. The supporting device according to claim 1, wherein
the positioning reference section is disposed at a position that does not overlap with the placing location of the film in the support direction and has a protrusion step configured to contact the film in a direction that intersects the support direction.

7. The supporting device according to claim 6, wherein
the protrusion step is a step less than or equal to the thickness of the film.

8. The supporting device according to claim 1, wherein
the film is rectangular and
the positioning reference section corresponds to a position that is overlapped by a corner of the film.

9. The supporting device according to claim 1, wherein
the film is rectangular and
the positioning reference section corresponds to a position along which an edge of the film is to be aligned.

10. The supporting device according to claim 1, wherein
the support section is configured to support films of different sizes and
the positioning reference section is disposed corresponding to the films of different sizes.

11. The supporting device according to claim 10, wherein
a plurality of different types of positioning reference sections are disposed so as to be distinguishable from each other in accordance with the films of different sizes.

12. The supporting device according to claim 10, wherein
the static electricity generating section is configured to switch the occurrence state of static electricity in accordance with films of different sizes.

13. A printing device comprising:
a support section configured to support a film on a support surface;
a printing section configured to perform printing on the film supported by the support surface;
a static electricity generating section configured to generate static electricity at a static electricity generation location provided at a part of the support surface; and
a positioning reference section that is provided at the support surface and that indicates at least a part of a placing position where the film having a predetermined shape is placed, wherein
the positioning reference section is disposed in accordance with the predetermined shape such that a part of the film and the static electricity generation location overlap each other in a support direction of the film by the support surface.
